(19) United States
(12) Patent Application Publication
(10) Pub. No.: US 2022/0341725 A1
(43) Pub. Date: Oct. 27, 2022

(54) NON-INVASIVE ALIGNMENT METHOD AND SYSTEM FOR IMAGER-ILLUMINATOR OPTICAL MEASUREMENT MACHINES

(71) Applicant: QUALITY VISION INTERNATIONAL INC., Rochester, NY (US)

(72) Inventor: Daniel James Lawler Williams, Rochester, NY (US)

(21) Appl. No.: 17/240,345

(22) Filed: Apr. 26, 2021

(51) Int. Cl. G01B 11/02; G01B 11/00; G02B 27/30

(52) U.S. Cl. CPC G01B 11/022; G01B 11/005; G02B 27/30

(57) ABSTRACT

A backlight optical alignment system comprises an illumination system having an illumination pupil and an illuminator configured to generate an output, wherein the illumination system includes a rotationally symmetric illumination distribution having an illumination axis, an imaging system having an imaging sensor comprising at least one detector element, an imaging pupil, and an acceptance cone in object space of the imaging system having an optical axis, wherein at least a portion of the imaging pupil is filled by the illumination system output when a portion of the illumination distribution overlaps with the acceptance cone, and a first substrate disposed in object space between the illumination system and the imaging system, wherein the solid substrate is adjustable to generate a change in signal intensity from the imaging sensor when the illumination axis of the illumination distribution is misaligned with the optical axis of the acceptance cone.

### BACKGROUND OF THE INVENTION

### Field of the Invention

This invention relates to optical measurement machines for gathering metrological data from test objects and in particular, to methods and systems for aligning an imager and an illuminator of an optical measurement machine having rotationally symmetric angular distribution of light.

### Description of Related Art

Optical measuring systems for gathering metrological data from test objects allow measurements to be made without contacting the test object being measured. U.S. Pat. Nos. 10,701,259 and 9,784,564 teach various aspects of certain video measurement machines and are incorporated herein by reference in their entirety. One way optical measurement machines gather metrological data is by “backlighting” the test object. For example, the test object is illuminated by an illumination system from one direction and the test object is imaged by an imaging system from the opposite direction. When backlighting a test object, the test object itself appears dark to the imaging system and the remaining background appears light. Thus, the test object appears in silhouette. The object profiles are then identified by the points of transition between light and dark, where the light that surrounds or passes through the test object is contrasted with adjacent portions of the view at which light is blocked. Backlights of video measuring machines are typically designed to form a rotationally symmetric illumination distribution to maintain isometry. Typically, such optical imaging systems further include a rotationally symmetric imaging pupil transmission function.

Optical imaging systems have the complication of being sensitive to proper lighting of the part being measured, which is achieved in part, by proper alignment of an illumination system and imaging system of the optical imaging system. In optical imaging systems having a low numerical aperture (NA) illumination system and a low numerical aperture (NA) imaging system, aligning the two systems is difficult. Typically, a first adjustment of the relative angle and translational position between the two systems is made to permit some transmission of light through the system. Then, smaller adjustments are made to determine the highest transmission of light by maximizing the transmitted signal intensity on the sensor of the imaging system. That is, the intensity incident on the sensor of the imaging system depends on the alignment between the central axis of an illumination distribution to a central axis of the acceptance cone of the imaging system. Misalignment of the imaging system and illumination system results in a reduced intensity on the imaging sensor due to a smaller area of overlap between the illumination distribution and the acceptance cone of the imaging system. In a misaligned system, the illumination axis of symmetry is non-parallel to the imaging acceptance cone axis. While the process of random hunting (i.e., tip/tilt) in two-dimensional space provides an approximate alignment of the illumination system to the imaging system, it is unknown when the maximum intensity is reached since there is no feedback on which adjustments should be made to improve alignment, except for perceived historical changes as a function of manual adjustments. That is, the gradient of transmitted intensity is a function of a given adjustment. Thus, if optimal alignment is reached, there is no indicative feedback until the system is adjusted out of best alignment. Even if the adjustments are confined to angular ones (assuming the illuminator spatially and uniformly overfills the imager entrance pupil), nearly-random hunting in a two-dimensional space is time consuming and prone to error. Further, the point of local maximum transmission does not necessarily correspond to the best alignment.

### BRIEF SUMMARY OF THE INVENTION

A backlight optical alignment system and method is envisioned comprising an illumination system having an illumination pupil and a light source configured to generate an output, wherein the illumination system produces a rotationally symmetric illumination distribution having an illumination axis, an imaging system having an imaging sensor comprising at least one detector element, an imaging pupil, and an acceptance cone in the object space of the imaging system having an optical axis, wherein at least a portion of the imaging pupil is filled by the illumination system output when a portion of the illumination distribution overlaps with the acceptance cone; and a first substrate having tapered, transmissive surfaces disposed in object space between the illumination system and the imaging system, wherein the substrate is adjustable to generate a change in signal intensity from the imaging sensor when the illumination axis of the illumination distribution is misaligned with the optical axis of the acceptance cone.

A method of aligning a backlit optical system comprises producing an output from a light source of an illumination system, the output having an illumination distribution having an illumination axis, transmitting the output towards an imaging system having an imaging sensor, an imaging pupil and an acceptance cone having an optical axis, wherein at least a portion of the imaging pupil is filled by the output, adjusting a first solid substrate having tapered, transmissive surfaces about an optical axis located in object space between the illumination system and an imaging system, detecting whether changes in transmitted intensity in the imaging system occur as the first solid substrate is rotated, and if changes in transmitted intensity are detected, determining a direction and relative magnitude of misalignment between the illumination system and imaging system. The step of adjusting the solid substrate may include simultaneously introducing a plurality of solid substrates, including the first solid substrate, in the field of view of the imaging system with different rotational angles. The step of adjusting the solid substrate may also include rotating the solid substrate or the plurality of solid substrates to a plurality of positions. The step of adjusting the solid substrate further may include continuously rotating the solid substrate along an axis substantially perpendicular to the solid substrate and substantially parallel to the illumination axis and imaging system optical axis for at least one complete rotation. The method may further include detecting the signals of the locations of at least one fiducial marker to convert the substrate rotational direction to imaging system coordinates, which are typically more useful for determining which adjustments should be made. The method may further include the step of positioning the illumination axis approximately parallel to the imaging optical axis, wherein the backlight optical system is deemed aligned when parallel axes of rotational symmetry in object space between the illumination angular distribution and the imaging acceptance cone of the imaging system is obtained.

A backlight optical alignment system comprises an illumination system having a light source emitting an illumination distribution of non-coherent light along an optical path, the illumination distribution of light having a central axis, an imaging system having an imaging sensor and an acceptance cone along an optical axis, wherein an optimal alignment with respect to the illumination system is achieved when the illumination distribution of the illumination substantially overlaps the acceptance cone, and a solid substrate having tapered, transmissive surfaces, the solid substrate in the optical path to receive the non-coherent light and to generate a change in signal intensity from the imaging sensor if the central axis of the illumination distribution is not substantially aligned with the optical axis of the acceptance cone.

### BRIEF DESCRIPTION OF THE SEVERAL VIEWS OF THE DRAWING(S)

FIG. 1 is a schematic layout of an optical measurement system in accordance with an embodiment of this invention.

FIG. 2 is a schematic view of the optical measurement system of FIG. 1 showing an imaging system and an illumination system.

FIG. 3 is a schematic view of an imaging system and illumination system that are misaligned with respect to each other.

FIG. 4 is top view of a wedge window for optimizing an alignment position of the imager and light source, the wedge window view having an arrow illustrating the direction of a thickness gradient.

FIG. 5 is a cross-sectional view of the wedge window for optimizing an alignment position of the imager and light source, taken along lines 4-4 of FIG. 4, the arrow illustrating the direction of the thickness gradient and a dashed line indicating a substantially perpendicular rotation axis.

FIG. 6 is a schematic view of an optical measurement system having a wedge window for optimizing an alignment position of the imager and light source.

FIG. 7 is a graphical representation of an angular deviation in degrees as a function of window tilt in degrees for a wedge window having a wedge angle of 1.5-degrees.

FIG. 8A is a flattened view of the relative angular positions for one distribution for select rotational positions for an optical measurement system having an aligned imager and illuminator.

FIG. 8B is a trace of an overlap area as a function of wedge rotation the optical measurement system of FIG. 8A having an aligned imager and illuminator.

FIG. 8C is a flattened view of the relative angular positions for one distribution for select rotational positions for an optical measurement system having a misaligned imager and illuminator.

FIG. 8D is a trace of an overlap area as a function of wedge rotation for the optical measurement system of FIG. 8C having a misaligned imager and illuminator.

FIG. 9 is a schematic view of a linear array of optical wedge window sectors oriented in a plurality of wedge angle directions.

FIG. 10 is a schematic view of an arrangement of wedge window sectors disposed together in a fixture to form an approximate circle to provide a near even sampling of the rotational space.

FIG. 11 is a schematic view of an arrangement of a circular wedge window cut into eight sector sections.

FIG. 12 is a schematic view of the wedge window of FIG. 11 showing a positional rearrangement of the sector sections.

FIG. 13 is a schematic view of the wedge window of FIG. 12 showing certain sectors rotated 180 degrees about its radial axis.

FIG. 14 is a top view of the arrangement of wedge window sectors of FIG. 10 showing an intensity that is substantially the same through all sections.

FIG. 15 is a flowchart showing an exemplary method in accordance with an embodiment of the invention.

### DETAILED DESCRIPTION OF THE INVENTION

At the outset, it should be appreciated that like reference numbers are intended to identify the same structural elements, portions, or surfaces consistently throughout the several drawing figures, as such element, portions or surfaces may be further desired or explained by the entire written specification, or which this detailed description is an integral part. Unless otherwise indicated, the drawings are intended to be read together with the specification, and are to be considered a portion of the entire written description of this invention.

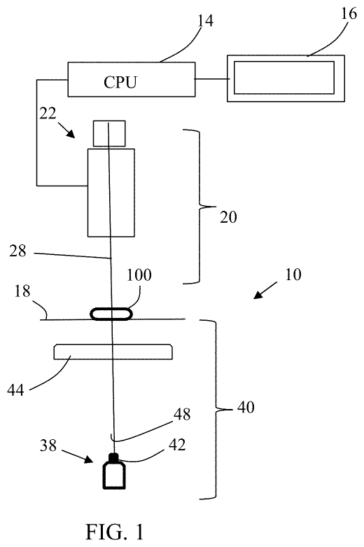

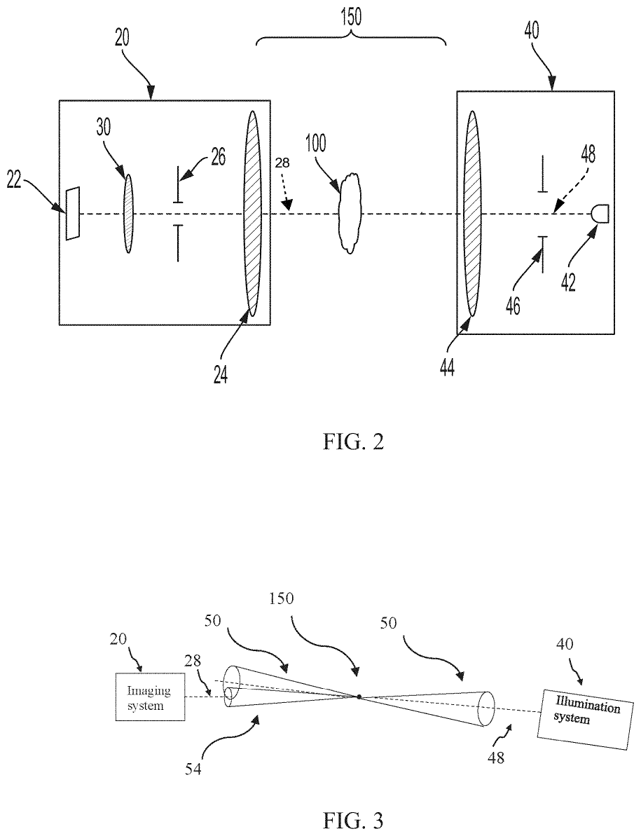

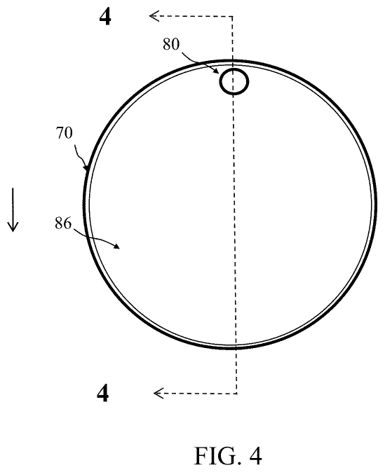

FIGS. 1 and 2 are schematic layouts of an optical measurement system 10 for measuring a test object 100 with an imaging system 20 which is aligned with an illumination system 40 using a wedge window 70 (shown in FIGS. 4, 5, 6, 9 and 10) in accordance with one aspect of this disclosure. The imaging system 20 is arranged for detecting transmitted light from the illumination system 40 on the opposite side of the test object 100, producing what is known as diascopic illumination. The imaging system 20 includes at least an imager 22, for example, an arrayed image sensor, which can be aligned along a common optical axis 28 of the optical measurement system 10. In one configuration, the imaging system 20 further includes at least one imaging objective lens 24 and an imaging pupil 26 produced by an aperture stop at that location. In a configuration, the imaging system 20 also includes a rear lens 30 with the imager 22 in the image plane. Preferably, the imaging pupil transmission function is rotationally symmetric or near rotationally symmetric. Typically, the imaging system 20 has a nearly uniform (unity) transmittance over the angular extent of a circular aperture stop and a uniform, zero transmittance beyond that angular extent, which qualifies as a rotationally symmetric angular distribution. The optical measurement system 10 is illuminated by an illumination system 40, which is depicted in FIGS. 1 and 2 as a backlighting system. In a configuration, the illumination system 40 includes an illuminator 38 having a light source 42 and a collimating lens 44. The light source 42 in one configuration is a non-coherent light source. For example, in one configuration, the light source 42 is a light emitting diode (LED) or a plurality of LEDs. In another configuration, the light source 42 is an incandescent lamp, high intensity discharge (HID) lamp, or superluminescent diode (SLD or SLED).

Although one collimating lens is shown, it should be appreciated that additional optical components may be included. Typically, the collimating lens 44 is a collimation lens providing collimated rays. The illumination system 40 further includes an illumination pupil 46 produced by an aperture stop at that location and an illumination axis 48 produced by the alignment of the illumination pupil 46 and the collimating lens 44. The illumination system 40 in one configuration is aligned with the optical axis or “centerline” 28 of the optical measurement system 10. The objective lens 24 of the imaging system 20, together with the collimating lens 44 of the illumination system 40, images the illumination pupil 46 of the illumination system 40 onto the imaging pupil 26 of the imaging system 20. It should be appreciated that the illumination distribution of the illumination system 40 preferably has a rotationally symmetric angular distribution about the illumination axis 48 to maintain isometry. Typically, the angular extents of the imaging system 20 and illumination system 40 are relatively small and similar in magnitude. For example, in one configuration, the angular extent of the imaging system 20 ranges from ±0.1 to ±3 degrees and the angular extent of the illumination system 40 ranges from ±0.1 to ±3 degrees. In one configuration, the angular distribution of the illumination system is nearly constant over the imager 22, which lies in a plane perpendicular to the optical axis 28. In one configuration, the angular extent of the illumination system 40 exceeds the angular extent of the imaging system 20. In one configuration, the angular distribution of the illumination system and the acceptance cone of the imaging system 20 are nearly constant over the field of view of the imaging system 20.

In one configuration, the imaging system 20 is in communication with a central processing unit (CPU) 14 which communicates with a display 16. The CPU 14 may be a computer programmed to position the object by adjusting a stage 18, set the magnification, adjust the illumination levels for each light source and automatically determine the location and dimensions of features of the object based on a video signal produced by the imaging system 20. In a configuration, the elements of the imaging system 20 are controlled by a computer which is the same computer that determines the location and dimensions of the features of the test object 100.

The optical measurement system 10, using the optical alignment measurement system 56, including but not limited to using a wedge window 70 for alignment as disclosed herein, has an angular distribution of the illumination system 40 that is constant or nearly constant over a spatial extent that exceeds the spatial extent of the field of view of the imaging system 20. This reduces the alignment optimization to the two angular dimensions of relative angle as described below. Two exemplary optical measurement systems 10 for which the alignment wedge may be used are the TurnCheck™ system and the Fusion® system, each available from Optical Gaging Products, Inc. However, it should be appreciated by those having ordinary skill that other optical measurement systems having measuring and video capabilities may be aligned using the wedge window 70 to align an imaging system 20 and an illumination system 40 of the system.

Before a measurement of the test object 100 is taken, the alignment between the imaging system 20 and the illumination system 40 is typically optimized. The alignment between the imaging system 20 and the illumination system 40 is optimized when substantially parallel axes of rotational symmetry between the illumination angular distribution and the imaging acceptance distribution in object space are obtained. In the configurations shown in FIGS. 1 and 2, the illumination system 40 and the imaging system 20 are aligned as the illumination axis 48 aligns with the optical axis 28.

FIG. 3 is a schematic layout of a generic optical measurement system illustrating the alignment procedure when the illumination system 40 and imaging system 20 are misaligned. For illustration, it should be assumed that at every object plane point 150, illumination system 40 produces a uniform illumination angular distribution 50 with a circular outer boundary with no light beyond the circular boundary at a given constant polar angle. The imaging system 20 will preferably receive any light from object plane point 150 that falls within its acceptance cone 54. Because the illumination angular distribution 50 does not completely cover the acceptance cone 54, the pixels of the imager 22 associated with the illustrated point in the object plane 150 will receive less light than it would if the system were aligned. The intensity of light striking the imager 22 is proportional to the area of overlap of the illumination angular distribution 50 and the acceptance cone 54.

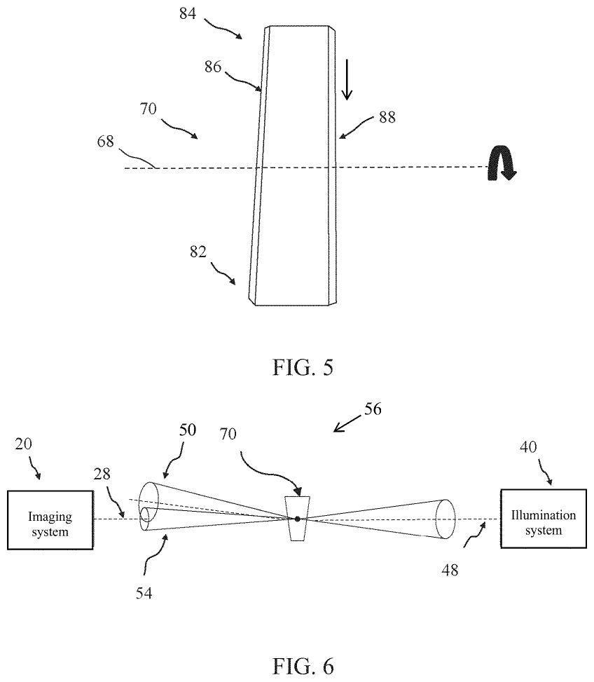

Turning now to FIGS. 4-6, to align the optical measurement system 10 using the optical measurement alignment system 56, the illumination from the illumination system 40 is deviated by a constant polar angle and a variety of azimuthal angles. In one configuration, this controlled deviation is achieved by inserting a substrate having tapered transmissive surfaces in the object plane as shown in FIG. 6. For example, the substrate in one configuration is a wedge window 70, as shown in FIGS. 4 and 5, and is sometimes referred to as an optical window. This solid substrate, or wedge window 70 includes a planar front surface 86 and a planar back surface 88 that have a small relative angle between their surface normal as illustrated in FIG. 5. Preferably, the surfaces 86, 88 have minimal reflectance. In one configuration, the front and back surfaces of the wedge window 70 are uncoated and have approximately 4% or less reflection per surface. It should be appreciated that a small wedge angle provides a mild refractive prism, deviating incident light rays by a small angle in a direction of the thicker portion of the wedge window 70. Unlike typical prisms with relative surface angles measured in tens of degrees, the wedge window 70, in a configuration, includes angles of approximately 1 degree. The wedge angle may range, however, from 0.25 degrees to 10 degrees for systems with F/#s in the range between F/200 and F/10. Typically, the wedge window 70 includes any available optical glass refractive index, which is preferably approximately 1.5, but can range from 1.45 to 2.0. In one configuration, the wedge window 70 is N-BK7 glass with a refractive index of approximately 1.52 for much of the visible spectrum. An example of a commercially available wedge window is provided at www.thorlabs.com, part number WW11050.

As shown in FIG. 6, to optimize the alignment of the imaging system 20 and the illumination system 40 of an optical measurement system 10, a plurality of controlled and temporary misalignments, that is deviation of the illumination by a constant polar angle and a variety of azimuthal angles, are purposefully introduced using the substrate that can be adjusted within the system 10, such as wedge window 70. When the illumination distribution is misaligned with the optical axis 28 of the imaging system acceptance cone 54, a change in signal intensity from the imager 22 is generated. Thus, the optical alignment measurement system 56, using the adjustable substrate, provides feedback on the alignment of the imaging system 20 and illumination system 40. Such feedback provided by the optical alignment measurement system 56 includes data on the transmitted intensity gradient as a function of angular misalignment, without making adjustments to the optical measurement system 10 itself. Moreover, the feedback identifies the adjustments needed to be made to provide a preferred optimized alignment.

The wedge window 70 deviates transmitted light by an angle that is largely insensitive to the angle of the incident light relative to the optical surfaces. Thus, the optical window 70 does not need to be placed in object space at a precise angle. Additionally, the translational position of the wedge window 70 can be varied since the wedge angle and therefore, angle of deviation, is constant throughout the aperture of the imaging system 20. Finally, the axial position of the wedge window 70 can be varied provided the illumination system 40 covers a large enough spatial extent. If the spatial extent is small, however, it is preferable to place the window near the object plane to minimize signal loss due to translational displacement of the illumination relative to the imaging system 20.

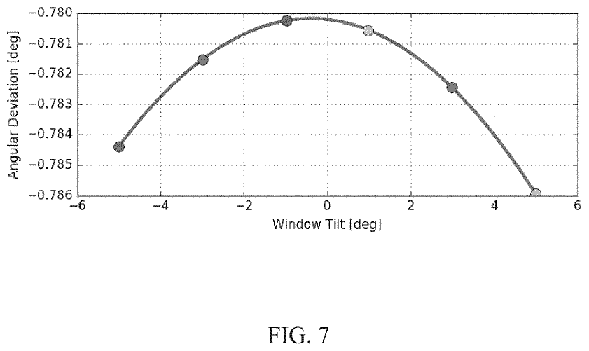

By way of example, a wedge window 70 with refractive index of about 1.5 and a wedge angle of 1.5° has an absolute expected angular deviation of approximately 0.781°. Tilting the wedge window 70 away from the minimum deviation orientation by up to ±5° only incurs a change in deviation of about 0.006°, or 0.8% of the absolute deviation as provided in FIG. 7. Less severe wedge angles, for example, 0.5° are useful for certain applicable F/100 (NA≈1/(2*F−Number)=0.005) optical systems, have even lower window tip/tilt sensitivity. In certain configurations, wedge windows 70 may be stacked to produce an overall, compound angle. For example, if the target wedge angle is 1°, two optical windows, each having and angle of 0.50°, can be stacked. Moreover, by rotating the wedge windows with respect to one another, the compound wedge angle can be adjusted continuously from the absolute difference of the two wedge angles up through their sum providing a wide range of adjustment.

Once the wedge window 70 is placed in the object plane of the system 10, the next step is to observe the relative intensity on the imager 22 as a function of the azimuthal deviation induced by the wedge window 70. The azimuthal angle is changed by adjusting the wedge window 70. In one configuration, the azimuthal angle is changed by rotating the wedge window 70 about an axis 68 approximately perpendicular to its front 86 and back 88 surfaces and approximately parallel to the optical axis 28. Rotating the wedge window 70 induces changes in the angle between the illumination axis 48 and the optical axis 28 if the system is misaligned, thus causing intensity changes on the imager 22; however, if the system is aligned, the angle between the axes of symmetry remains constant and equal to the wedge window deviation angle, resulting in a constant intensity on the imager 22. Once an optimal alignment of the imaging system 20 with respect to the illumination system 40 is achieved, the wedge window 70 is removed from the optical path.

An optimally aligned system consisting of a rotationally symmetric illumination angular distribution 50 and a rotationally symmetric acceptance cone 54 will show no change in pixel intensity as the wedged window 70 is rotated through a full rotation. This is because the wedge-induced angle between the illumination axis 48 and the optical axis 28 is constant for all azimuthal angles. Thus, the intersection of the two distributions provides a constant transmission of light. Four specific methods for obtaining and using pixel intensity data from the wedge window 70 at different rotational positions are provided below: manual rotation, motorized rotation, static fixture, and hybrid spinning static fixture.

Manual Rotation

In one configuration, the manual rotation method comprises manually rotating the wedged window 70 to induce a controlled deviation relative to the alignment of the imaging system 20 and the illumination system 40 and monitoring a change to the pixel intensity on the imager 22 in real time. By rotating the wedge window 70, a direction of deviation is determined and the wedge angle determines the relative magnitude of misalignment. Typically, when the imaging system 20 and the illumination system 40 of the optical measurement system 10 are close to alignment, there will be a monotonic intensity compared to the polar angle misalignment function in the region accessed by the wedge window 70. When misaligned, however, one rotational position will have the least intensity, while the 180° opposite rotational position will often have the greatest intensity. To make an adjustment, minimum and maximum pixel intensities on the imager 22 are observed, then the wedge window 70 is rotated to one of the extremes. The optical measurement system 10 alignment is adjusted to bring the intensity near the average of the extremes. This is repeated by finding new extremes, presumably of more similar intensities than the previous determination, and making another adjustment.

In one configuration, the wedge window 70 includes a fiducial mark 80 on the wedged window 70. The fiducial marker 80 in one configuration can indicate the thickest edge 82 or thinnest edge 84 of the wedge window 70, as shown in FIG. 5. As shown in FIG. 4, fiducial marker 80 indicates the thinnest edge 84. The fiducial mark 80 can help determine which adjustments to make. For example, if the thickness gradient of the wedge window 70 is pointing horizontal, the horizontal angle between the imaging system 20 and illumination system 40 should be adjusted. The direction of the angular adjustment of the optical measurement system 10 can be determined by considering the geometry of the wedge window 70 and the optical measurement system 10, knowing which extreme (high or low) the wedge window 70 is positioned in, and understanding that the light is deviated towards the thick portion of the wedge window 70.

Motorized Rotation

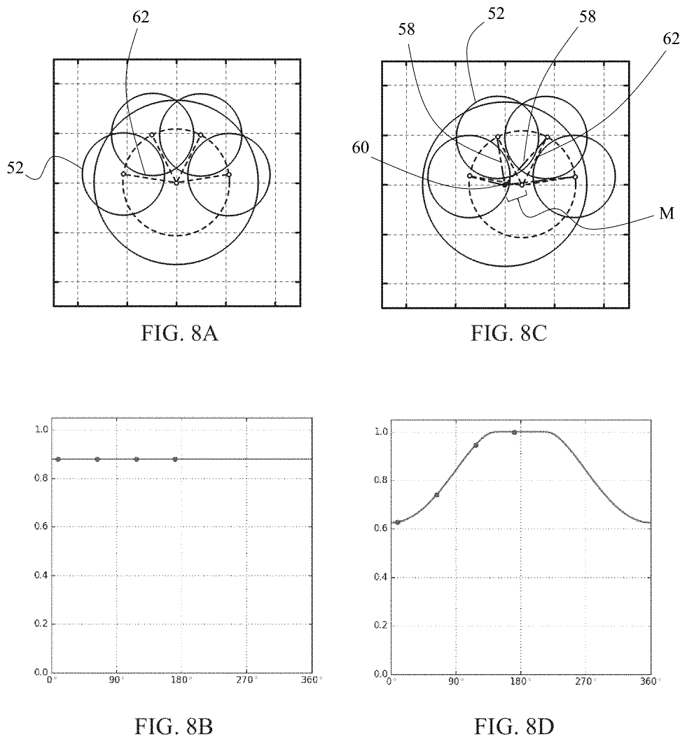

In another configuration, changes to pixel intensity can be monitored while the wedge window 70 rotates freely or via an electromechanical mechanism. Pixel intensity analysis software may be used to further analyze and calculate the required adjustment. If the intensity is sampled many times per rotation, a dense trace can be created as illustrated in FIGS. 8A-8D. In FIGS. 8A and 8C, the relative angular positions for one distribution are shown for select rotational positions. The “tip” system misalignment is shown along the x-axis and the “tilt” system misalignment is shown along the y-axis. Each of the smaller solid lined circles 52 shows a relative angular position for the imaging system's acceptance cone for select rotational positions. The radial dash-dot lines 58 show the total wedge-induced misalignment and point 60 represents the illumination axis 48. The length of each line 58 indicates the polar angle of the total misalignment, if any. The dashed lines have a constant length and show the constant deviation resulting from the wedge window 70. The system misalignment distance is identified as distance M in FIG. 8C. A trace of overlap area as a function of wedge rotation is provided in FIGS. 8B and 8D. FIGS. 8A and 8B show an optimally aligned system and FIGS. 8C and 8D show a misaligned system. Thus, the trace provides near real-time feedback of the system alignment, wherein a constant-valued trace indicates an optimally aligned system. Knowing which direction the wedge window 70 is oriented is useful for determining adjustment(s) to make to achieve optimal alignment. In one configuration, an encoder on the rotation fixture is provided to determine the orientation of the wedge window 70. In another configuration, the orientation of the wedge window 70 is determined by alignment software by detecting a fiducial on, for example, the thinnest edge 84 of the wedge window 70. If the trace is then registered to the system geometry and considered a nearly sinusoidal function, the relative phase of the traced signal indicates the direction of misalignment while the amplitude represents the severity of misalignment. In one configuration, the analysis software analyzes the intensity trace and provides guidance on the alignments to be made in real time. In another configuration, the user adjusts the alignment of the imaging system 20 and the illumination system 40 using the trace signal.

Static Fixture

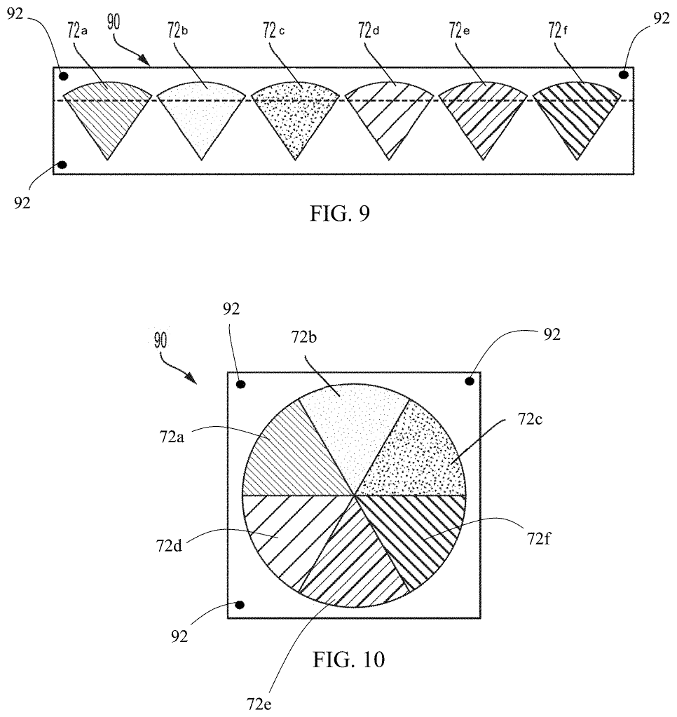

Turning now to FIGS. 9-12, in another configuration, the wedge window 70 or solid substrate is not rotated, but instead is static. Having a plurality of solid substrates in the field of view (FoV) of the imaging system 20 with different relative wedge rotation directions can provide enough information regarding the pixel intensity through each window to estimate the magnitude of intensity changes and the direction of misalignment, just as in the motorized rotation method. For instance, the misaligned system shown in FIG. 8 produces an approximately sinusoidal intensity trace, as will many distributions when the wedge window 70 accesses a semi-linear monotonic portion of the intensity vs. misalignment function. For example, if the intensity vs. wedge rotation is sampled at a plurality of known rotational positions (0 to 360°), then a sine function can be fit to those points and the alignment parameters estimated by the user.

In one configuration, the solid substrate is a plurality of wedge window sectors, which are mounted in a frame or fixture 90 or 94 so that their relative rotation angles remain constant. Additionally, fiducial marks 92 on the fixture 90 or 94 that are visible in the FoV of the imaging system 20 can provide a reference for the wedge rotation angles relative to the system geometry so that the misalignment direction can be identified. After the fixture 90 or 94 is positioned within the FoV, the average pixel value from each pre-measured sector is determined. Then, the pixel values in each pre-measured sector are analyzed considering the pre-measured wedge angle direction. This determines a magnitude and direction of the misalignment. In a misaligned system, an approximately sinusoidal intensity trace will be obtained when intensity is plotted as a function of wedge rotation angle.

Whatever the rotational sampling, knowing the rotational positions of the wedge window' sectors is important. This can be measured in a variety of ways. In one configuration, commercially available autocollimators, such as those available by Micro-Radian Instruments are used to measure non-parallelism in windows. A fixture holding the windows can be mounted on translation stage(s) to move the different wedged windows 70 into the autocollimator beam and the relative angles (and wedge angle magnitudes) can be recorded.

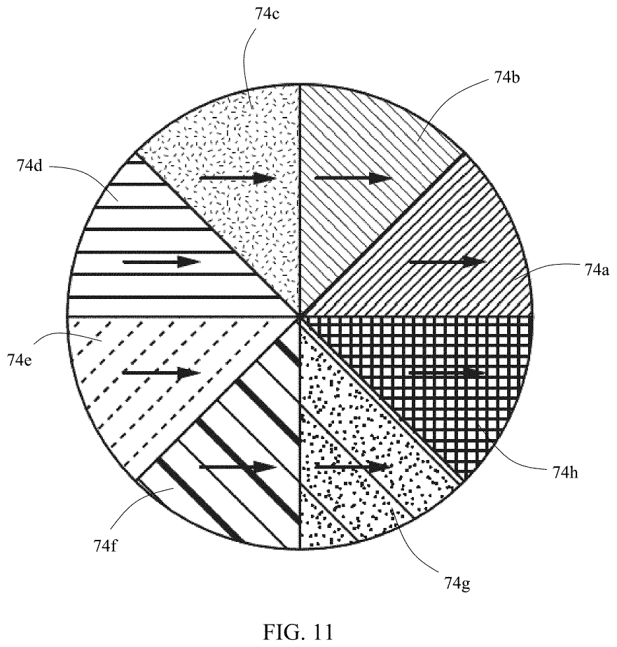

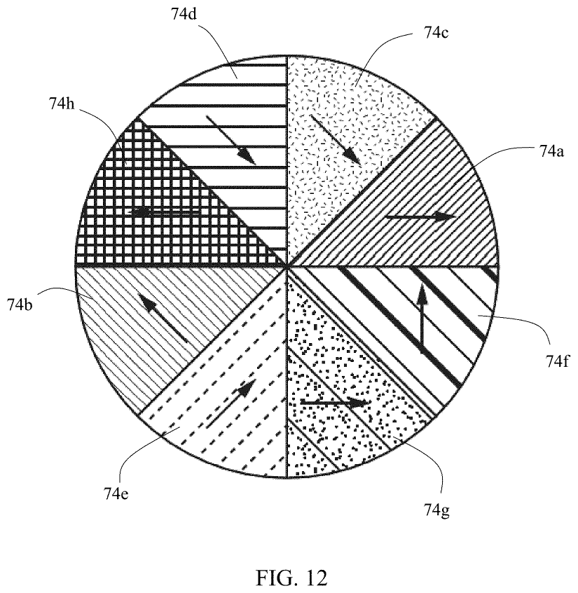

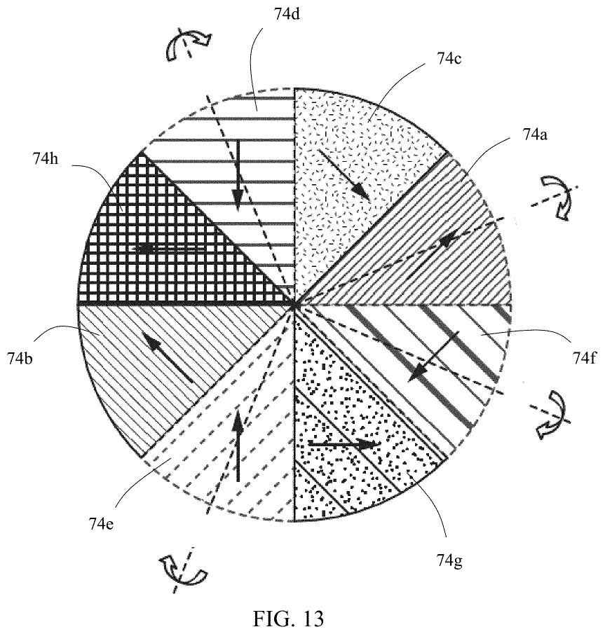

If the shapes of the illumination angular distribution 50 and imaging system acceptance cone 54 (or the intensity vs. misalignment function) are known very well, each of the plurality of wedge sectors need not have a common wedge angle to estimate the alignment parameters. With this information and knowledge of the wedged window fixture 90 geometry, different wedge angles can be compensated for during software analysis. However, it is more generally applicable to have all the wedge sectors share a common wedge angle. This way, the software analysis can be the same for most pairs of rotationally symmetric distributions. In certain configurations, several windows 70 with very similar or the same wedge angle can be used. In one configuration, a single wedge window 70 can be cut into several wedge sectors, for example, wedge sectors 72a-72f of FIGS. 9 and 10 and wedge sectors 74a-74h of FIGS. 11-13 having the same or approximately the same wedge angle. The wedge sectors 72a-72f are oriented in a fixture 90 or 94 configured to receive a plurality of sectors so that the rotational position is approximately evenly sampled as provided in FIGS. 9 and 10. In one configuration, the wedge window 70 is divided into six sectors 72a-72f, each sector having an angle of approximately 60 degrees. In another configuration, the window 70 is divided into eight sectors 74a-74h, each sector having an angle of approximately 45 degrees. It should be appreciated that the wedge window 70 may be cut into any number of pieces. In one configuration, the window is cut into one of 4, 6, or 8 approximately equal pieces. Further, it should be appreciated that the wedge sectors can vary in size and do not need to be evenly spaced if the position and size of each sector is known by the system.

As shown in FIG. 9, in one configuration, wedge window 70 sectors 72a-72f are disposed in a linear array in fixture 90 with all the sectors oriented in the same direction relative to their physical profile. In this configuration, the wedge window 70 sectors 72a-72f have the same or approximately the same wedge angles. Typically, the wedge gradient is aligned to the center of one of the sectors 72a-72f or along one of the sector 72a-72f straight edges. This configuration is particularly useful for systems with single- or few-row imaging sensors such as on shaft measuring machines, for example the TurnCheck™ system sold by Optical Gaging Products, Inc. At least one fiducial marker 92 is included on the fixture 90. In one configuration, the fixture includes three fiducial markers 92.

The circular or “pie” configuration as shown in FIG. 10 has an advantage over the linear configuration as shown in FIG. 9 in that all the sectors 72a-72f are in close proximity to all other pieces, making visual comparison of intensities easier and mitigating the effect of possible field-dependent misalignments. In the circular configuration, a monolithic wedge window 70, for example as shown in FIG. 4, is cut into approximately equal sectors 72a-72f and then rearranged in fixture 90 or 94 such that the sectors in each position have a different wedge direction. It should be appreciated that several different rotational sampling arrangements are possible and can be used to align the system provided that the arrangement is correctly identified and input into the system. FIG. 11 shows an example of a wedge window 70 divided into eight sectors 74a-74h yet to be rearranged to provide different wedge angles and directions. It should be appreciated that the arrow shown in FIG. 4 indicates the thickness gradient, or wedge direction, which corresponds to the arrows provided in FIGS. 11-13. As shown in FIGS. 4 and 5, the arrow points towards the thickest portion of the window. Next, and as shown in FIG. 12, wedge sectors 74a-74h are rearranged to provide different wedge directions in certain positions. To achieve different wedge directions in each position, certain sectors must be flipped, or rotated 180 degrees about its radial axis. As shown in FIG. 13, for example, each of sectors 74a, 74d, 74e, and 74f are rotated 180 degrees about its radial axis. Thus, wedge sectors 74a-74h each have a different wedge direction and are then secured in fixture 90, 94. In this configuration, with eight sectors, a different wedge direction is present at 45 degree intervals.

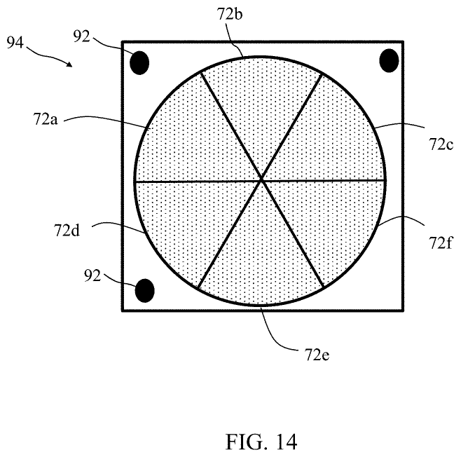

If the static fixture 90, 94 is used to align the system 10 by eye using a live view of the imager 22 signal, the static fixture 90, 94 can be rotated to ensure the wedge sectors, for example wedge sectors 72a-72f or 74a-74h, are uniform at intensity at a variety of fixture orientations to confirm the optimized alignment position is achieved. The user views only a single set of sample wedge directions at any instant, rather than coalescing various sets of sample wedge directions into a denser sampling. FIG. 14 shows wedge sectors 72a-72f within static fixture 94 having a uniform intensity through each sector 72a-72f, which indicates an optimized alignment position of the system has been achieved.

Whatever the rotational sampling, the rotational positions of the wedge window sectors 72a-72f or 74a-74h need to be determined and input into the system. The rotational sampling of each sector 72a-72f or 74a-74h can be measured in a variety of ways as described above. It should be appreciated that the shading in FIGS. 9-13 is not intended to illustrate different substrate materials, but rather different rotational positions of the wedge window sectors. A fixture 90 or 94 holding the sectors 72a-72f or 74a-74h can be mounted on translation stage(s) to move the different sectors 72a-72f or 74a-74h into the autocollimator beam and the relative angles (and wedge angle magnitudes) can be recorded.

If the shapes of the illumination angular distribution 50 and imaging system acceptance cone 54 (or the intensity vs. misalignment function) are known, each of the plurality of wedge sectors 72a-72f or 74a-74h need not have a common wedge angle to estimate the alignment parameters. With this information and knowledge of the wedged window fixture 90 or 94 geometry, different wedge angles can be compensated for during software analysis. However, it is more generally applicable to have all the wedge sectors 72a-72f or 74a-74h share a common wedge angle. This way, the software analysis can be the same for most pairs of rotationally symmetric distributions.

The static fixture 90, 94 provides an easy visual alignment without requiring software analytics. The simultaneously visible contrasting intensities are easier to compare than a single time-varying intensity level. Alignment of the optical measurement system 10 is optimized when using the static fixture 90, 94 when all the wedge sectors 72a-72f or 74a-74h transmit the same intensity. As such, this can provide a better alignment than the default maximum transmission method. Further, since only a single frame of data is required to perform the analysis of alignment, using the static fixture 90, 94 to align the system is faster.

Hybrid Spinning Static Fixture

In yet another configuration, the static fixture 90, 94 as described above and shown in FIGS. 9 and 10 can be rotated. For example, if a “pie” static fixture type with six sectors is rotated through 60 degrees, the rotational position could be as densely sampled as the rotating wedge method, but with ⅙^{th} the number of acquired images.

Mounting

It should be appreciated that the wedge window 70 can be mounted within the optical measurement system 10. Typically, the wedge window 70 is approximately perpendicular to the rotation axis wherein light can pass through it. The wedge rotation axis 68 is approximately aligned to the machine's optical axis 28. In one configuration, the wedge rotation axis 68 is aligned to ±5 degrees, and less than ±5 degrees for higher wedge angles.

Exemplary Method

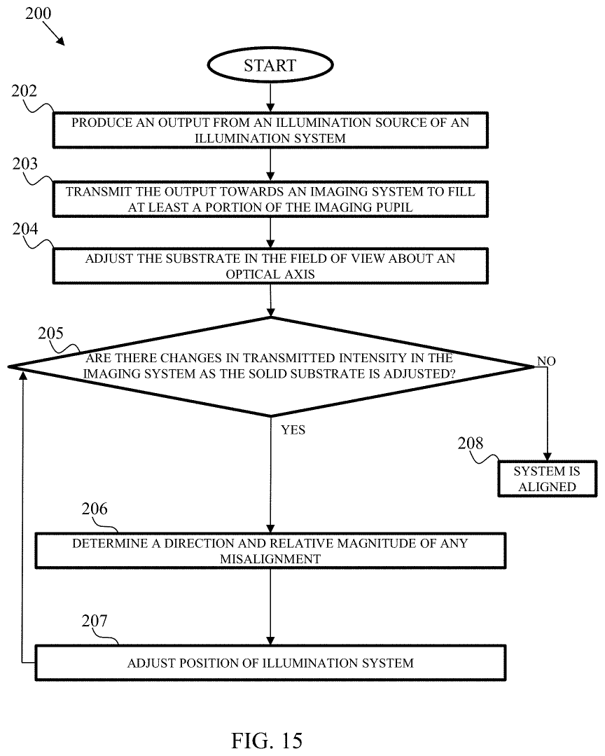

FIG. 15 is a flowchart showing an exemplary method in accordance with an embodiment of the invention. The method is initiated by, at step 202, producing an illumination source, for example, output from a light source 42 of an illumination system 40 of an optical measurement system 10. The output is transmitted towards an imaging system 20 to fill at least a portion of the imaging pupil 24 according to step 203. A substrate, for example wedge window 70, is adjusted in the field of view about an optical axis 28 according to step 204. In one configuration, the step of adjusting the wedge window 70 includes introducing a plurality of wedge sectors 72a-72f or 74a-74h in the field of view of the imaging system 20 with different rotational angles simultaneously. In another configuration, the step of adjusting the wedge window 70 includes rotating the wedge window 70 in a plurality of positions. In another configuration, the step of adjusting includes continuously rotating the wedge window 70 along a substantially perpendicular axis for at least one complete rotation.

Thereafter, in step 205, it is determined whether there are changes in the transmitted pixel intensity in the imaging system 20 as the wedge window 70 is adjusted. In one configuration, the signals of the locations of at least one fiducial marker 80 are detected and the signal between the locations is plotted. If no changes in pixel intensity are observed, the system 10 is deemed aligned according to step 208. If changes in pixel intensity are observed, then a direction and relative magnitude of misalignment are determined according to step 206 and the position of the illumination system 40 is adjusted according to step 207. In one configuration, the change of transmitted intensity on the image sensor 22 is observed as a function of the azimuthal deviation introduced by the wedge window 70. At that point, steps 205-207 are repeated until no further changes in the transmitted intensity in the imaging system 20 are detected, at which point the system 10 is deemed aligned according to step 208 and the wedge window 70 is removed from the optical path. The optical measuring system 10 is aligned when parallel axes of rotational symmetry 28,48 in object space between the illumination angular distribution 50 and the imaging system acceptance cone 54 is obtained.

1. A backlight optical alignment system comprising:
(a) an illumination system having an illumination pupil and a light source configured to generate an output, wherein the illumination system produces a rotationally symmetric illumination distribution having an illumination axis;
(b) an imaging system having an imaging sensor comprising at least one detector element, an imaging pupil, and an acceptance cone in object space of the imaging system having an optical axis, wherein at least a portion of the imaging pupil is filled by the illumination system output when a portion of the illumination distribution overlaps with the acceptance cone;
(c) a first solid substrate having tapered, transmissive surfaces disposed in object space between the illumination system and the imaging system, wherein the solid substrate is adjustable to generate a change in signal intensity from the imaging sensor when the illumination axis of the illumination distribution is misaligned with the optical axis of the acceptance cone.

2. The backlight optical alignment system of claim 1, wherein the solid substrate is a plurality of solid substrates with different rotational angles simultaneously in a field of view of the imaging system to generate a plurality of signal intensities from regions of the imaging sensor associated with the solid substrates when the illumination axis of the illumination distribution is misaligned with the optical axis of the acceptance cone.

3. The backlight optical alignment system of claim 1, wherein the solid substrate is rotated in a plurality of positions to generate the change in signal intensity from the imaging sensor when the illumination axis of the illumination distribution is misaligned with the optical axis of the acceptance cone.

4. The backlight optical alignment system of claim 1, wherein the solid substrate is a solid substrate operable to continuously rotate along a substantially perpendicular axis for at least one complete rotation.

5. The backlight optical alignment system of claim 3, wherein the solid substrate is rotated along a substantially perpendicular axis.

6. The backlight optical alignment system of claim 1, wherein the change in signal intensity on the image sensor is observed as a function of an azimuthal deviation introduced by the solid substrate adjustment.

7. The backlight optical alignment system of claim 1, wherein the solid substrate is an optical window having a thick portion and a thin portion, wherein the optical window deviates the output of the light source by an angle in the direction of the thick portion of the optical window.

8. The backlight optical alignment system of claim 7, wherein the optical window includes a planar front surface and a planar back surface, wherein each surface has a non-zero angle between a surface normal of each surface in the range of approximately 0.25 degrees to 10 degrees.

9. The backlight optical alignment system of claim 8, wherein the surface angle of the front and back surface of the optical window is approximately 1 degree.

10. The backlight optical alignment system of claim 1, wherein the solid substrate includes a fiducial mark indicating the direction of deviation of transmitted light.

11. The backlight optical alignment system of claim 10, wherein the fiducial mark is positioned on the thick portion of the optical window.

12. A method of aligning a backlit optical system comprising:
(a) producing an output from a light source of an illumination system, the output having an illumination distribution having an illumination axis;
(b) transmitting the output towards an imaging system having an imaging sensor, an imaging pupil and an acceptance cone having an optical axis, wherein at least a portion of the imaging pupil is filled by the output;
(c) adjusting a first solid substrate having tapered, transmissive surfaces about a substrate axis that is substantially perpendicular to the first solid substrate and substantially parallel to at least one of the illumination axis and the optical axis, the first solid substrate located in object space between the illumination system and an imaging system;
(d) detecting on an image sensor whether changes in transmitted intensity in the imaging system occur as the first solid substrate is rotated; and
(e) if changes in transmitted intensity are detected, determining a direction and relative magnitude of misalignment between the illumination system and imaging system.

13. The method of claim 12, wherein the step of adjusting the solid substrate includes simultaneously introducing a plurality of solid substrates, including the first solid substrate, in a field of view of the imaging system with different rotational angles.

14. The method of claim 13, wherein the step of adjusting the solid substrate includes rotating the solid substrate, or the plurality of solid substrates, to a plurality of positions.

15. The method of claim 12, wherein the step of adjusting the solid substrate includes continuously rotating the solid substrate along the substrate axis for at least one complete rotation.

16. The method of claim 12, wherein the solid substrate is a wedge having a thick portion and a thin portion, wherein the thick portion includes at least one fiducial marker that generates a signal of a location of the at least one fiducial marker when the wedge is rotated.

17. The method of claim 16, further comprising the step of detecting the signals of the locations of the at least one fiducial marker and plotting the signal based on a rotation angle estimated by the at least one fiducial marker location.

18. The method of claim 12, wherein the solid substrate is rotated along a substantially perpendicular axis.

19. The method of claim 12, wherein the change of transmitted intensity on the image sensor is observed as a function of the azimuthal deviation introduced by the solid substrate.

20. A backlight optical alignment system comprising:
(a) an illumination system having a light source emitting an illumination distribution of non-coherent light along an optical path, the illumination distribution of light having a central axis;
(b) an imaging system having an imaging sensor and an acceptance cone along an optical axis, wherein an optimal alignment with respect to the illumination system is achieved when the illumination distribution of the illumination substantially overlaps the acceptance cone; and
(c) a solid substrate having tapered, transmissive surfaces, the solid substrate in the optical path to receive the non-coherent light and to generate a change in signal intensity from the imaging sensor if the central axis of the illumination distribution is not substantially aligned with the optical axis of the acceptance cone.
